(19) United States
(12) Patent Application Publication
(10) Pub. No.: US 2025/0226496 A1
(43) Pub. Date: Jul. 10, 2025

(54) BULKHEAD SEAL

(71) Applicant: Carl Freudenberg KG, Weinheim (DE)

(72) Inventors: Thomas KRAMER, Zotzenbach (DE); Peter KRITZER, Forst (DE); Manuel HASIEBER, Mörlenbach (DE); Michael BLAKE, Northville, MI (US); Nico CALANDRA, Viernheim (DE); Richard ZUBER, Gorxheimertal (DE); Manuel HILLE, Heppenheim (DE)

(21) Appl. No.: 19/007,771

(22) Filed: Jan. 2, 2025

(30) Foreign Application Priority Data
Jan. 4, 2024 (DE) 10 2024 100 211.5

(51) Int. Cl. H01M 50/184; H01M 50/186; H01M 50/195

(52) U.S. Cl. CPC H01M 50/184; H01M 50/186; H01M 50/195

(57) ABSTRACT

A bulkhead seal for sealing storage modules from one another in a common housing, the storage modules being separated by a bulkhead. The bulkhead seal includes a mounting portion, first sealing lip, second sealing lip, and central sealing lip. The central sealing lip is disposed between the first and second sealing lip so that a first interstitial space is formed between the central and first sealing lips and a second interstitial space is formed between the second and central sealing lips. The first, second, and central sealing lip are configured to contact the housing. The first sealing lip is configured to seal the first energy storage module from the first interstitial space. The second sealing lip is configured to seal the second energy storage module from the second interstitial space. The central sealing lip is configured to seal the first interstitial space from the second interstitial space.

### CROSS REFERENCE TO RELATED APPLICATIONS

This application claims benefit to German Patent Application No. DE 10 2024 100 211.5, filed on Jan. 4, 2024, which is hereby incorporated by reference herein.

### FIELD

The present disclosure relates to a bulkhead seal and to a bulkhead with a bulkhead seal, a housing, and an electrical energy storage device.

### BACKGROUND

Electrical energy storage devices are increasingly used for providing energy for electrically powered vehicles, but also for stationary applications. A frequently used energy storage system is a rechargeable storage device in the form of a lithium-ion battery. In addition to lithium-ion batteries, lithium-sulfur batteries, solid-state batteries, sodium-ion batteries, or batteries based on other light metals, such as magnesium or aluminum, or metal-air batteries, may also be used. Furthermore, supercapacitors are also suitable as energy storage systems. Lithium-ion batteries, like other rechargeable storage devices for electrical energy, generally have a plurality of energy storage cells, which are assembled together in a housing.

Such electrical energy storage devices can have safety-relevant consequences if they malfunction. For example, excessive temperatures, internal and external short-circuits in the individual cells can cause irreversible damage to the energy storage system. In this context, “thermal runaway” is known, particularly in connection with lithium-ion cells. During a thermal runaway, the energy stored in the cell is released in a sudden and uncontrolled manner. When this occurs, large amounts of thermal energy as well as gaseous and particulate reaction products are released within a short period of time, resulting in high pressure and high temperatures in the housing. The reaction products released must be removed from the battery housing in a rapid and controlled manner. For this purpose, battery housings have dedicated emergency vents through which the excessive pressure can be relieved. During a thermal runaway of a cell, electrically conductive particles are ejected as reaction products in addition to hot gases at temperatures which may be above 1000° C. depending on the cell chemistry used and pressures of typically at of least 1 MPa. These particles are, for example, carbon particles or metallic particles, metal droplets, and salts of different composition. It is particularly critical when the hot particle streams can act for too long on other cells. This may cause them to also undergo a thermal runaway, which may result in an uncontrolled chain reaction.

Usually, a plurality of electrically interconnected energy storage cells are combined to form a module. The modules are generally separated from each other by bulkheads. In the event of a thermal runaway of a cell in a first module, these bulkheads have the function of protecting the cells in an adjacent second module, particularly from the hot particle streams.

One possible design would be to join the bulkheads downward to the housing bottom and upward to the cover by material-to-material bonding, for example, by welding. This configuration has the technical problem that the individual modules are no longer accessible in the event of repair. Moreover, joining housing components of different materials can be problematic. Furthermore, assembly tolerances may complicate the joining of the components.

### SUMMARY

In an embodiment, the present disclosure provides a bulkhead seal for sealing a first energy storage module from a second energy storage module in a common housing, the first energy storage module and the second energy storage module being separated from each other by a bulkhead, the bulkhead seal comprising a mounting portion adapted to be mounted on the bulkhead, a first sealing lip, a second sealing lip, and a central sealing lip. The central sealing lip is disposed between the first sealing lip and the second sealing lip so that a first interstitial space is formed between the central sealing lip and the first sealing lip and a second interstitial space is formed between the second sealing lip and the central sealing lip. The first sealing lip, the second sealing lip, and the central sealing lip are configured to contact the housing. The first sealing lip is configured to seal the first energy storage module from the first interstitial space. The second sealing lip is configured to seal the second energy storage module from the second interstitial space. The central sealing lip is configured to seal the first interstitial space from the second interstitial space.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic perspective view of an electrical energy storage device having a bulkhead seal according to an embodiment;

FIG. 2 illustrates a schematic sectional view showing the bulkhead seal in an undeformed state;

FIG. 3 illustrates a schematic sectional view showing the bulkhead seal in an installed state;

FIG. 4 illustrates a schematic sectional view showing the bulkhead seal pressurized from one side;

FIG. 5 illustrates a schematic sectional view of the bulkhead seal according to an embodiment;

FIG. 6 illustrates a schematic sectional view of the bulkhead seal according to an embodiment; and

FIG. 7 illustrates a schematic sectional view of the bulkhead seal according to an embodiment.

### DETAILED DESCRIPTION

In an embodiment, the present disclosure provides a bulkhead seal, a bulkhead, a housing, and an electrical energy storage device which are simple and inexpensive to manufacture and provide reliable sealing performance between two energy storage modules of an electrical energy storage device, in particular in the event of a thermal runaway of cells in one of the energy storage modules.

In particular, the bulkhead seal should be capable of responding quickly to a sudden increase in pressure on one side and should not lose its imperviousness, even when exposed to hot particle streams. Furthermore, the bulkhead seal should be attachable to narrow bulkheads and capable of compensating for large tolerances between the bulkhead and the housing.

The bulkhead seal according to the present disclosure has the advantage of being capable of sealing a first energy storage module from a second energy storage module when one of the energy storage modules undergoes a thermal runaway. The bulkhead seal according to the present disclosure is able to continue to perform its sealing function when hit by a hot particle stream. The bulkhead seal is capable of responding quickly to a sudden increase in pressure and is attachable to narrow bulkheads. Moreover, the bulkhead seal is capable of compensating for large tolerances between the bulkhead and the housing.

This is achieved in accordance with the present disclosure by the bulkhead seal including a mounting portion adapted to be mounted on the bulkhead. The bulkhead seal further includes a first sealing lip, a second sealing lip, and a central sealing lip. The central sealing lip is disposed between the first sealing lip and the second sealing lip so that a first interstitial space is formed between the central sealing lip and the first sealing lip and a second interstitial space is formed between the second sealing lip and the central sealing lip. The first sealing lip, the second sealing lip, and the central sealing lip are configured to contact the housing in the installed state. The first sealing lip is configured to seal the first energy storage module from the first interstitial space. The second sealing lip is configured to seal the second energy storage module from the second interstitial space, and the central sealing lip is configured to seal the first interstitial space from the second interstitial space and the second interstitial space from the first interstitial space. In the event of thermal runaway in the first or second energy storage module, the first or the second sealing lip can thus function as a sacrificial sealing lip, which can be and is allowed to become brittle by the hot particle stream. The embrittled first or second sealing lip functions as a mechanical barrier that prevents in particular hot particle streams from damaging other elements of the bulkhead seal, particularly the central sealing lip. Together with the undamaged first or second sealing lip, the central sealing lip maintains the sealing function of the bulkhead seal.

The first and the second interstitial spaces are outwardly open in the non-installed state and closed by the housing in the installed state.

The bulkhead seal according to the present disclosure is a profiled seal. The first sealing lip, the second sealing lip, and the central sealing lip preferably have a W-shaped cross section.

The bulkhead seal is preferably extruded, but can also be manufactured as a molded part.

In the installed state, the first sealing lip and the second sealing lip are bent outwardly by the contacting housing so that they can effectively seal an increase in pressure from the first or second energy storage module against the housing.

In the installed state, the central sealing lip is preferably compressed by the housing so that the central sealing lip can provide a reliable seal on both sides in the event of an increase in pressure in the first interstitial space or in the second interstitial space.

Preferably, the central sealing lip has a hollow cavity. The hollow cavity enables improved tolerance compensation, while at the same time reducing the compression force on the central sealing lip, thereby contributing to an improved sealing performance.

Furthermore, the first sealing lip and the second sealing lip are preferably configured mirror-symmetrically to a plane of the bulkhead. The bulkhead plane is coplanar with the bulkhead and intersects it centrally. This makes it possible to obtain a bulkhead seal that has the same sealing properties toward the first energy storage module and toward the second energy storage module.

In accordance with another preferred embodiment of the present disclosure, the first sealing lip and the second sealing lip are higher than the central sealing lip when in the undeformed state. Thus, in the installed state, the first sealing lip and the second sealing lip bend preferably outwardly away from the bulkhead seal and rest with an inner surface of the sealing lip against the housing. Thus, the first sealing lip and the second sealing lip can be activated by pressure from outside to provide a seal against the first or second interstitial space and have fast response characteristics.

Preferably, the first sealing lip and the second sealing lip are 2.3 to 3.7 times higher than the central sealing lip when in the undeformed state. This ensures that in the installed state, the first sealing lip and the second sealing lip rest securely against the housing and provide a reliable seal.

Furthermore, the first sealing lip and/or the second sealing lip are/is preferably oriented at an angle from 40° to 50° to the bulkhead plane when in the undeformed state. The angle is preferably measured from a central plane of the first sealing lip and/or the second sealing lip to the bulkhead plane. In the case of a narrow mounting portion, this enables the formation of a first interstitial space and a second interstitial space, which interstitial spaces improve the sealing properties and protect the central sealing lip. The angular disposition of the first sealing lip and/or the second sealing lip also enables the seal to respond quickly to pressure changes and provides improved protection against particle streams.

The bulkhead seal preferably includes a first central sealing lip and a second central sealing lip, with a third interstitial space being formed between the first central sealing lip and the second central sealing lip. The first central sealing lip is configured to seal the first interstitial space from the third interstitial space, and the second central sealing lip is configured to seal the second interstitial space from the third interstitial space. The additional central sealing lip can further improve the sealing properties of the bulkhead seal, in particular in the event of the first or second sealing lip being damaged by a hot particle stream. Preferably, the first central sealing lip and the second central sealing lip are oriented outwardly at an angle with respect to the bulkhead plane so that their sealing property is improved when activated by pressure.

The bulkhead seal is preferably made from a silicone elastomer. Silicone elastomers exhibit increased thermal stability. In addition, under the action of heat, they convert into mineral substances (silicon dioxide), which leaves a protective framework after exposure to high thermal stress. Thus, after the first and second sealing lips are destroyed by the action of heat thereon, they continue to provide mechanical protection of the central sealing lip.

Furthermore, the bulkhead seal preferably includes flame-resistant and/or abrasion-resistant fillers. Such fillers include, for example, mineral fillers in the form of particles, platelets, and fibers, such as, for example, aluminum trihydroxide or other mixed metal oxide-hydroxides. The fillers make it possible to further improve the flame-resistant and abrasion-resistant properties of the bulkhead seal.

Preferably, the bulkhead seal has an intumescent coating. The intumescent coating is applied in particular in the first interstitial space and/or in the second interstitial space. Intumescent coatings are fire-protection coatings which expand forming an insulation layer and which reduce the heat impact on the bulkhead seal. By application of the intumescent coating in the first interstitial space and/or in the second interstitial space, the central sealing lip can be protected from thermal stress by activation of the intumescent coating in the event of a thermal runaway in the first energy storage module or in the second energy storage module.

The mounting portion of the bulkhead seal is preferably configured to be slip-fitted onto the bulkhead. Alternatively, the mounting portion is configured to be inserted into a groove of the bulkhead. A slip-fitted or inserted mounting portion and the bulkhead preferably form a force-fitting and/or frictional connection therebetween. In addition or alternatively, the mounting portion can preferably be configured to be connected to the bulkhead by a material-to-material bond. This makes it possible to ensure a reliable connection between the bulkhead seal and the bulkhead. Moreover, this enables attachment of the bulkhead seal to thin bulkheads.

The present disclosure also relates to a bulkhead having a bulkhead seal as described hereinbefore.

Moreover, the present disclosure relates to a housing for an electrical energy storage device, including a side wall, a cover, a bottom plate, and a bulkhead as described hereinbefore.

Preferably, the bulkhead seal of the housing is disposed between the bulkhead and the cover and/or between the bulkhead and the side wall and/or between the bulkhead and the bottom plate. This enables easy assembly and reliable sealing by means of the bulkhead, the bulkhead seal, and the cover. Moreover, the cover can be easily removed for repair without destroying it.

The present disclosure further relates to an electrical energy storage device including a housing as described hereinbefore, a first energy storage module, and a second energy storage module, the first energy storage module and the second energy storage module being disposed in the housing and separated from each other by the bulkhead and the bulkhead seal.

Further details, advantages, and features of the present disclosure will be apparent from the following description of exemplary embodiments, taken in conjunction with the drawings.

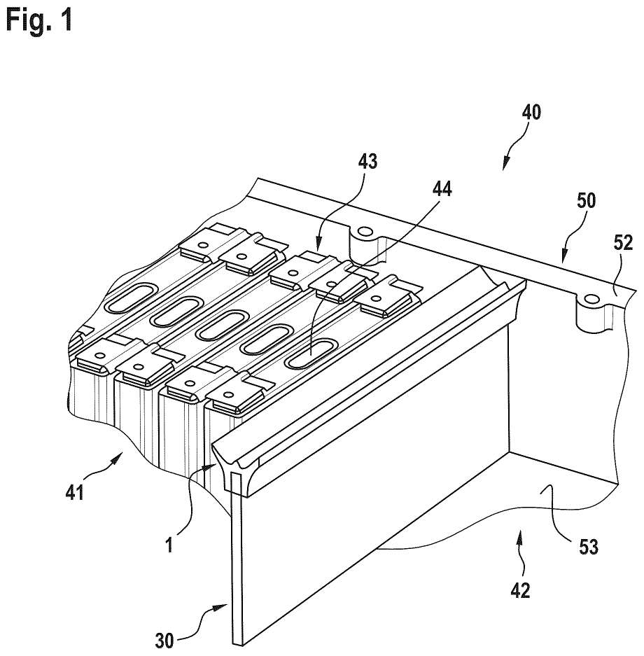

A bulkhead seal 1 of an electrical energy storage device 40 for sealing a first energy storage module 41 from a second energy storage module 42 in a common housing 50 according to the present disclosure will now be described in detail with reference to FIGS. 1 through 4.

FIG. 1 shows a schematic configuration of electrical energy storage device 40, including a first energy storage module 41 and a second energy storage module 42. First energy storage module 41 and second energy storage module 42 are disposed in housing 50 on a base plate 53 and surrounded by a side wall 52 of housing 50.

Bulkhead 30 is disposed between first energy storage module 41 and second energy storage module 42 and provides a physical and thermal barrier. Disposed on bulkhead 30 is bulkhead seal 1 according to the first exemplary embodiment, which is adapted to contact a cover 51 of housing 50. Bulkhead seal 1 extends along the entire length of bulkhead 30. Alternatively or additionally, bulkhead seal 1 can be disposed between bulkhead 30 and side wall 52 and seal electrical energy storage device 40 at side wall 52.

A plurality of prismatic battery cells 43 are disposed in first energy storage module 41. Prismatic battery cells 43 have a rupture vent 44 adapted to open when activated by pressure and/or temperature in the event of a thermal runaway of a prismatic battery cell 43 and to discharge a cell chemistry to the outside. Preferably, second energy storage module 42 also has a plurality of prismatic batteries cells 43 disposed therein.

Bulkhead 30 and bulkhead seal 1 together enable reliable protection of first energy storage module 41 and second energy storage module 42 from damage caused by thermal runaway of one of the adjacent energy storage modules 41, 42. Electrical energy storage device 40 preferably includes a plurality of energy storage modules 41, 42, which are separated from each other by bulkheads 30 and bulkhead seals 1.

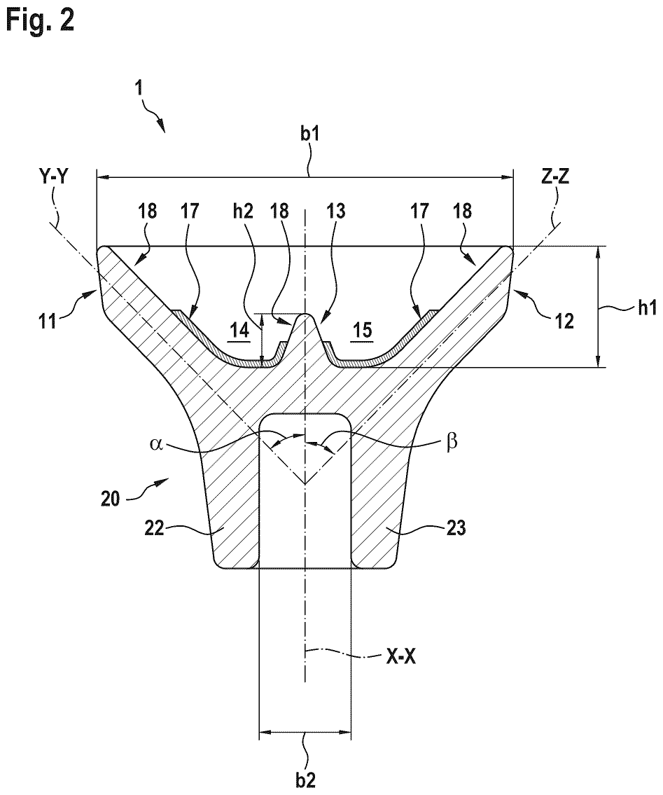

FIG. 2 shows, in schematic sectional view, bulkhead seal 1 according to the first exemplary embodiment in the undeformed state. Bulkhead seal 1 has a mounting portion 20, which is configured to be slip-fitted onto a bulkhead 30.

Mounting portion 20 includes a first arm 22 and an opposite second arm 23, which are configured to contact bulkhead 30 laterally on both sides and to provide a frictional connection. In addition, a material-to-material bond can be formed between bulkhead seal 1 and bulkhead 30 by an adhesive that is introduced between bulkhead seal 1 and bulkhead 30.

A first sealing lip 11 and a second sealing lip 12 are attached laterally above mounting portion 20. First sealing lip 11 merges smoothly into first arm 22, and second sealing lip 12 merges smoothly into second arm 23. First sealing lip 11 and second sealing lip 12 are configured mirror-symmetrically to a bulkhead plane X-X. Bulkhead plane X-X is coplanar with bulkhead 30 and intersects it centrally.

First sealing lip 11 has a first central plane Y-Y that intersects first sealing lip 11 centrally. First sealing lip 11 is configured such that first central plane Y-Y is oriented at a first angle α of 45° to bulkhead plane X-X.

Second sealing lip 12 has a second central plane Z-Z that intersects second sealing lip 12 centrally. Second sealing lip 12 is also configured such that second central plane Z-Z is oriented at a second angle β of 45° to bulkhead plane X-X.

A central sealing lip 13 is disposed between first sealing lip 11 and second sealing lip 12. Bulkhead plane X-X forms the central plane of central sealing lip 13.

A first interstitial space 14 is formed between first sealing lip 11 and central sealing lip 13. Similarly, a second interstitial space 15 is formed between second sealing lip 12 and central sealing lip 13.

An intumescent coating 17 is applied on bulkhead seal 1 in the area of first interstitial space 14 and second interstitial space 15. In the non-pressurized state, intumescent coating 17 is not applied in a contact area 18 of first sealing lip 11, second sealing lip 12, and central sealing lip 13 so as not to impair the sealing properties thereof. Contact area 18 is configured to contact housing 50 of electrical energy storage device 40.

In the undeformed state, bulkhead seal 1 preferably has a first width b1 of 11.4 mm between first sealing lip 11 and second sealing lip 12. First width b1 is measured perpendicularly to bulkhead plane X-X and describes the maximum width of bulkhead seal 1.

In the undeformed state, mounting portion 20 has a second width b2 of 2.5 mm between first arm 22 and second arm 23. Second width b2 is dependent on the thickness of bulkhead 30 and is preferably selected such that an interference fit or transition fit is present between mounting portion 20 and bulkhead 30.

First sealing lip 11 and second sealing lip 12 have a first height h1 of 3.3 mm. First height h1 is measured parallel to bulkhead plane X-X between the lowest point of first or second interstitial space 14, 15 and the highest tip of first sealing lip 11 or second sealing lip 12.

Central sealing lip 13 has a second height h2 of 1.4 mm. Second height h2 is measured parallel to bulkhead plane X-X between the lowest point of first or second interstitial space 14, 15 and the tip of central sealing lip 13. Thus, in the undeformed state, first sealing lip 11 and second sealing lip 12 are 2.36 times higher than central sealing lip 13.

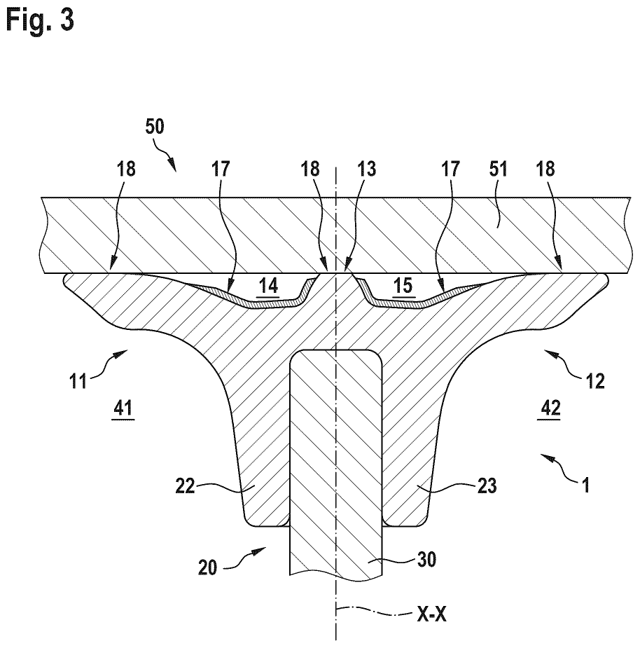

FIG. 3 shows bulkhead seal 1 according to the first exemplary embodiment in the deformed state between bulkhead 30 and cover 51 of housing 50.

Cover 51 exerts a force on bulkhead seal 1 so that first sealing lip 11 and second sealing lip 12 are bent outwardly from bulkhead plane X-X. Contact areas 18 of bulkhead seal 1 rest against cover 51 and exert a force on cover 51 so that first sealing lip 11 seals first energy storage module 41 from first interstitial space 14, and second sealing lip 12 seals second energy storage module 42 from second interstitial space 15. In the event of an increase in pressure in first or second energy storage module 41, 42, the outwardly bent shape of first and second sealing lips 11, 12 increases the force of contact area 18 on housing 50, thereby increasing the sealing properties of bulkhead seal 1.

The outwardly bent shape of first and second sealing lips 11, 12 also increases the force of first and second arms 22, 23 on bulkhead 30.

Central sealing lip 13 is compressed by cover 51 along bulkhead plane X-X so that central sealing lip 13 provides good sealing on both sides between first interstitial space 14 and second interstitial space 15.

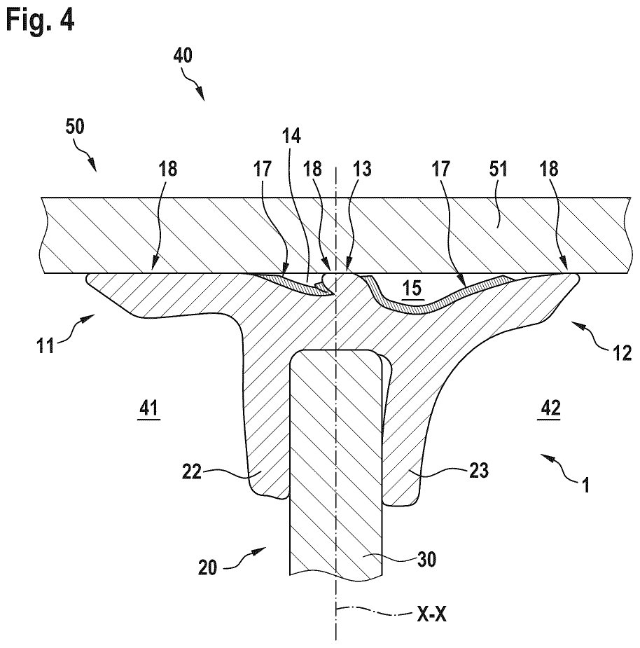

FIG. 4 illustrates a simulation result of bulkhead seal 1 according to the first exemplary embodiment, where a pressure of 1000 kPa is present in electrical energy storage device 40 in first energy storage module 41 and a pressure of 100 kPa in second energy storage module 42. Bulkhead seal 1 is mounted on bulkhead 30 and contacts cover 51 of housing 50.

The pressure conditions simulate the load on bulkhead seal 1 in the event of a thermal runaway of first energy storage module 41. Due to the pressure difference, bulkhead seal 1 deforms, causing first sealing lip 11 to be pressed more strongly against cover 51 and increasing contact area 18 between first sealing lip 11 and cover 51. The pressure difference between first energy storage module 41 and second energy storage module 42 causes central sealing lip 3 to be displaced toward second energy storage module 42. Contact area 18 between central sealing lip 13 and cover 51 remains substantially unchanged. Due to the pressure difference, sealing lip 12 bends further toward second energy storage module 42, thereby reducing the contact area 18 between second sealing lip 12 and cover 51.

If, in the event of a thermal runaway in first energy storage module 41, first sealing lip 11 should be thermally heavily stressed or exposed to a particle stream so that first sealing lip 11 gets damaged and loses its sealing property, central sealing lip 13 and second sealing lip 12 will still seal first energy storage module 41 from second energy storage module 42. Without central sealing lip 13, second sealing lip 12 would lose its sealing properties in the event that the first sealing lip gets damaged.

Even in a damaged state, first sealing lip 11 protects central sealing lip 13 from damage. In the case of a damaged first sealing lip 11, first interstitial space 14 forms a thermal insulation layer that protects central sealing lip 13 from thermal damage. Intumescent coating 17 in first interstitial space 14 can expand when activated by temperature and further improve the thermal insulating property of first interstitial space 14. Preferably, such expansion is moderate so that the increase in volume does not result in mechanical damage to central sealing lip 13 or in a deterioration of its sealing property.

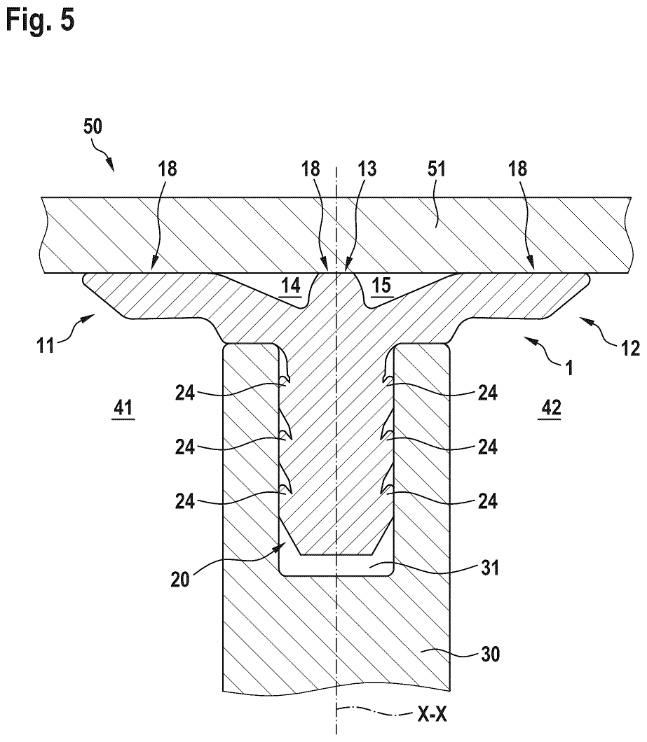

FIG. 5 shows the cross section of a bulkhead seal 1 according to a second exemplary embodiment. Bulkhead seal 1 is mounted in a groove 31 of the bulkhead and provides a seal against cover 51 of housing 50.

First sealing lip 11, second sealing lip 12, and central sealing lip 13 of the second exemplary embodiment correspond to the first exemplary embodiment. However, no intumescent coating 17 is applied in the area of first interstitial space 14 and second interstitial space 15.

The mounting portion 20 of the second exemplary embodiment differs from the first exemplary embodiment. The bulkhead seal 1 in FIG. 5 has three elastic barbs 24 on either side, which exert a force on the side walls of groove 31. Thus, mounting portion 20 forms a frictional connection between bulkhead 30 and bulkhead seal 1.

Additionally, an interlocking connection between the barbs 24 of the bulkhead seal and bulkhead 30 can be formed by means of a corresponding structure of groove 31.

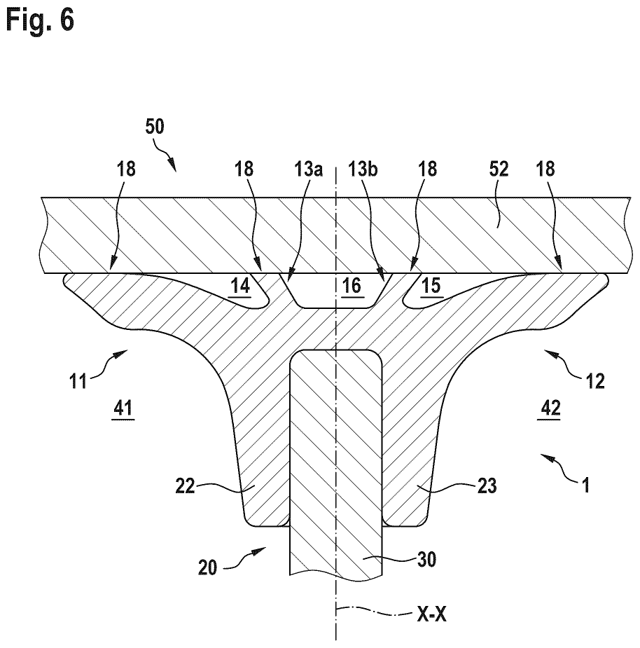

FIG. 6 shows the cross section of bulkhead seal 1 according to a third exemplary embodiment. In FIG. 6, bulkhead seal 1 is disposed between bulkhead 30 and side wall 52 of housing 50. The third exemplary embodiment has a mounting portion 20 comparable to that of the first exemplary embodiment.

In contrast to the first exemplary embodiment, the third exemplary embodiment has a first central sealing lip 13a and a second central sealing lip 13b. The additional sealing lip can increase the sealing property of bulkhead seal 1.

A third interstitial space 16 is formed between first central sealing lip 13a and second central sealing lip 13b. Moreover, first interstitial space 14 is still formed between first sealing lip 11 and first central sealing lip 13a. Similarly, second interstitial space 15 is still formed between second sealing lip 12 and second central sealing lip 13b.

First central sealing lip 13a and second central sealing lip 13b are oriented away from bulkhead plane X-X so that in the event of an increase in pressure in first interstitial space 14, contact area 18 of first central sealing lip 13a is pressed against side wall 52 when activated by pressure and improves the sealing property of bulkhead seal 1. Similarly, in the event of an increase in pressure in second interstitial space 15, contact area 18 of second central sealing lip 13b is pressed against side wall 52 upon activation by pressure and improves the sealing property of bulkhead seal 1.

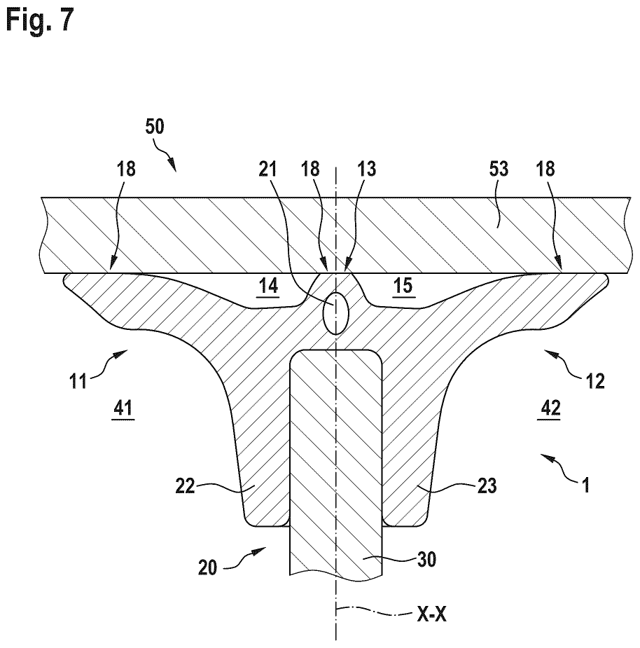

FIG. 7 shows a cross section of bulkhead seal 1 according to a fourth exemplary embodiment. Bulkhead seal 1 is mounted on bulkhead 30 and provides a seal against base plate 53 of housing 50.

Bulkhead seal 1 according to the fourth exemplary embodiment is configured analogously to bulkhead seal 1 according to the first exemplary embodiment and differs only by a hollow cavity 21 disposed in central sealing lip 13. Hollow cavity 21 is disposed centrally on bulkhead plane X-X between bulkhead 30 and housing 50.

Preferably, hollow cavity 21 extends in the longitudinal direction over the entire length of bulkhead seal 1.

Hollow cavity 21 can improve the resilience of central sealing lip 13 along bulkhead plane X-X in the direction of bulkhead 30. This makes it possible to provide improved tolerance compensation of central sealing lip 13 between bulkhead 30 and housing 50. Moreover, a uniform contact pressure can be ensured between housing 50 and central sealing lip 13, resulting in a reliable sealing property of bulkhead seal 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A bulkhead seal for sealing a first energy storage module from a second energy storage module in a common housing, the first energy storage module and the second energy storage module being separated from each other by a bulkhead, the bulkhead seal comprising:
a mounting portion adapted to be mounted on the bulkhead;
a first sealing lip;
a second sealing lip; and
a central sealing lip which is disposed between the first sealing lip and the second sealing lip so that a first interstitial space is formed between the central sealing lip and the first sealing lip, and a second interstitial space is formed between the second sealing lip and the central sealing lip,
the first sealing lip, the second sealing lip, and the central sealing lip being configured to contact the housing,
the first sealing lip being configured to seal the first energy storage module from the first interstitial space,
the second sealing lip being configured to seal the second energy storage module from the second interstitial space, and
the central sealing lip being configured to seal the first interstitial space from the second interstitial space.

2. The bulkhead seal as recited in claim 1, wherein the central sealing lip has a hollow cavity.

3. The bulkhead seal as recited in claim 1, wherein the first sealing lip and the second sealing lip are configured mirror-symmetrically to a bulkhead plane.

4. The bulkhead seal as recited in claim 1, wherein in an undeformed state, the first sealing lip and the second sealing lip are higher than the central sealing lip.

5. The bulkhead seal as recited in claim 4, wherein in the undeformed state, the first sealing lip and the second sealing lip are 2.3 to 3.7 times higher than the central sealing lip.

6. The bulkhead seal as recited in claim 1, wherein the first sealing lip and/or the second sealing lip are/is oriented at an angle of from 40° to 50° to the bulkhead plane when in the undeformed state.

7. The bulkhead seal as recited in claim 1, comprising a first central sealing lip and a second central sealing lip, wherein a third interstitial space is formed between the first central sealing lip and the second central sealing lip, wherein the first central sealing lip is configured to seal the first interstitial space from the third interstitial space, and wherein the second central sealing lip is configured to seal the second interstitial space from the third interstitial space.

8. The bulkhead seal as recited in claim 1, wherein the bulkhead seal is made from a silicone elastomer.

9. The bulkhead seal as recited in claim 1, wherein the bulkhead seal includes flame-resistant and/or abrasion-resistant fillers.

10. The bulkhead seal as recited in claim 1, wherein the bulkhead seal has an intumescent coating, in particular in the first interstitial space and/or in the second interstitial space.

11. The bulkhead seal as recited in claim 1, wherein the mounting portion is configured to be slip-fitted onto the bulkhead, or wherein the mounting portion is configured to be inserted into a groove of the bulkhead, and/or wherein the mounting portion is configured to be connected to the bulkhead by a material-to-material bond.

12. A bulkhead comprising the bulkhead seal according to claim 1.

13. A housing for an electrical energy storage device, comprising a side wall, a cover, a bottom plate, and the bulkhead according to claim 12.

14. The housing as recited in claim 13, wherein the bulkhead seal is disposed between the bulkhead and the cover and/or between the bulkhead and the side wall and/or between the bulkhead and the bottom plate.

15. An electrical energy storage device comprising the housing according to claim 13, a first energy storage module, and a second energy storage module, the first energy storage module and the second energy storage module being disposed in the housing and separated from each other by the bulkhead and the bulkhead seal.
